(19) United States
(12) Patent Application Publication
(10) Pub. No.: US 2023/0052211 A1
(43) Pub. Date: Feb. 16, 2023

(54) UV-CURABLE PRESSURE-SENSITIVE ADHESIVE COMPOSITION AND UV-CURABLE PRESSURE-SENSITIVE ADHESIVE TAPE

(71) Applicant: 3M INNOVATIVE PROPERTIES COMPANY, St. Paul, MN (US)

(72) Inventors: Lijing Zhang, Shanghai (CN); Shijing Cheng, Woodbury, MN (US)

(21) Appl. No.: 17/757,635

(22) PCT Filed: Jan. 4, 2021
(86) PCT No.: PCT/IB2021/050018

§ 371 Date: Jun. 17, 2022

(30) Foreign Application Priority Data
Jan. 6, 2020 (CN) 202010011776.9

(51) Int. Cl. C09J 7/10; C09J 7/38

(52) U.S. Cl. CPC C09J 7/10; C09J 7/385; C09J 2433/00; C09J 2463/00

(57) ABSTRACT

The present invention provides a UV-curable pressure-sensitive adhesive composition, comprising: 81 to 97.5 parts of (meth)acrylate polymer having a carboxyl functional group by weight, the amount of the carboxyl functional group in the (meth)acrylate polymer having the carboxyl functional group being equal to or greater than 40 mmol/100 g; 2.5 to 19 parts of an epoxy resin by weight; 0.3 to 6 parts of a polyol by weight; and 0.05 to 5 parts of a photoinitiator by weight. The UV-curable pressure-sensitive adhesive composition has good anti-repulsion. The present invention further provides a UV-curable adhesive tape comprising the UV-curable pressure-sensitive adhesive composition.

### TECHNICAL FIELD

The present invention relates to the technical field of pressure-sensitive adhesives, in particular to a UV-curable pressure-sensitive adhesive composition and a UV-curable pressure-sensitive adhesive tape.

### BACKGROUND

Following developments in technology, in the electronic products field, requirements for bonding strength have increased. Conventional pressure-sensitive adhesives cannot provide enough strength in some applications, whereas UV-curable adhesive films/tapes can provide greater bonding strength than pressure-sensitive adhesives.

Given such issues, in the electronic products field, a need exists for pressure-sensitive adhesives that can bond both plastic film substrates and metal substrates. For the metal substrates, pressure-sensitive adhesives must have strong peeling force on the metal substrates. For the plastic film substrates, pressure-sensitive adhesives must have excellent anti-repulsion. In particular, in application for flexible circuits, adhesive tapes applied to bent areas must have good anti-repulsion, especially after high temperature aging. Therefore, in the electronic products field, pressure-sensitive adhesives must have both excellent peeling force and excellent anti-repulsion, such that optimal bonding can be implemented for both plastic substrates and metal substrates.

### SUMMARY

According to one aspect of the present invention, the present invention provides a UV-curable pressure-sensitive adhesive composition, comprising: 81 to 97.5 parts of (meth)acrylate polymer having a carboxyl functional group by weight, the amount of the carboxyl functional group in the (meth)acrylate polymer having the carboxyl functional group being equal to or greater than 40 mmol/100 g; 2.5 to 19 parts of an epoxy resin by weight; 0.3 to 6 parts of a polyol by weight; and 0.05 to 5 parts of a photoinitiator by weight.

According to another aspect of the present invention, the present invention provides a UV-curable pressure-sensitive adhesive tape, the UV-curable pressure-sensitive adhesive tape comprising the UV-curable pressure-sensitive adhesive layer formed by the pressure-sensitive adhesive composition described above.

The UV-curable pressure-sensitive adhesive compositions and UV-curable pressure-sensitive tapes provided in the present invention have both excellent peeling force and excellent anti-repulsion after curing, particularly anti-repulsion after aging.

### DETAILED DESCRIPTION

The present invention provides a UV-curable pressure-sensitive adhesive composition, consisting of a (meth)acrylate polymer having a carboxyl functional group, an epoxy resin, a polyol and a photoinitiator at specific weight ratios. The photoinitiator is used for initiating curing of the epoxy resin. This photoinitiator, after being induced by ultraviolet light, can continue to react with an epoxy group at room temperature even after an ultraviolet light source is removed, so as to complete curing (namely, active polymerization).

The inventor of the present invention unexpectedly found that, when the weight ratio of the epoxy resin in the UV-curable pressure-sensitive adhesive composition is a specific value, a pressure-sensitive adhesive with excellent peeling force and excellent anti-repulsion can be obtained.

The “UV-curable pressure-sensitive adhesive composition” used herein refers to a pressure-sensitive adhesive composition defined by at least the following two features: (i) is tacky at room temperature initially and can adhere to object surface without extra heating; (ii) can get furtherly chemically crosslinked after being adhered to object surface. The crosslink can be triggered by UV lights. The UV-curable pressure-sensitive adhesive composition is the reactive material used to form a pressure-sensitive adhesive and is not a PSA itself. After UV curing, the UV-curable pressure-sensitive adhesive composition crosslinked and cured reaction product is a pressure-sensitive adhesive.

The UV-curable pressure-sensitive adhesive composition and the UV-curable pressure-sensitive adhesive tape will be described in more detail below.

The UV-curable pressure-sensitive adhesive composition provided by the present invention comprises the following components:
81 to 97.5 parts of (meth)acrylate polymer having a carboxyl functional group by weight, the amount of the carboxyl functional group in the (meth)acrylate polymer having the carboxyl functional group being equal to or greater than 40 mmol/100 g;
2.5 to 19 parts of an epoxy resin by weight;
0.3 to 6 parts of a polyol by weight; and
0.05 to 5 parts of a photoinitiator by weight.

The percentage, proportion, part, concentration and the like referred to in the present invention are based on weight unless otherwise specified.

a) (Meth)acrylate Polymer Having Carboxyl Functional Group

The UV-curable pressure-sensitive adhesive composition provided by the present invention comprises a (meth)acrylate polymer having a carboxyl functional group.

Herein, the term (methyl)acrylic acid refers to acrylic acid, methacrylic acid, or both. Similarly, the term (meth)acrylate refers to acrylate, methacrylate, or both. The (meth)acrylate polymer refers to a polymer formed by a polymerizable monomer which is mainly acrylic acid/acrylate and/or methacrylic acid/acrylate.

Herein, the (meth)acrylate polymer having the carboxyl functional group refers to that a (meth)acrylate polymer has a carboxyl group thereon. One of the methods for obtaining the (meth)acrylate polymer having the carboxyl functional group is formed through copolymerization by using a raw material comprising at least two polymerizable monomers, the polymerizable monomers comprising at least one monomer having the carboxyl functional group comprises acrylic acid, methacrylic acid, mono-2-(methacryloyloxy)ethyl succinate and mono-2-(acryloyloxy)ethyl succinate or the like.

In some embodiments, the polymerizable monomers of the (meth)acrylate polymer may comprise one or more substances selected from the group consisting of: C1-C10 alkyl acrylate, C3-C8 cycloalkyl acrylate, C6-C12 aryl acrylate, C1-C10 alkyl methacrylate, C3-C8 cycloalkyl methacrylate, or C6-C12 aryl methacrylate, wherein C1-C10 alkyl, C3-C8 cycloalkyl and C6-C12 aryl are capable of being substituted by one or more substituents. The substituents may be independently selected from hydroxy, amino, carboxy, and epoxy, or C3-C8 cycloalkyl, C6-C12 aryl or C6-C12 aryloxy optionally substituted by hydroxy, amino, carboxy or epoxy. Examples of C1-C10 alkyl acrylate include, but not limited to, methyl acrylate, ethyl acrylate, propyl acrylate, isopropyl acrylate, butyl acrylate, isobutyl acrylate, tert-butyl acrylate, hexyl acrylate, and etc. Examples of C1-C10 alkyl methacrylate include, but not limited to, methyl methacrylate, ethyl methacrylate, propyl methacrylate, isopropyl methacrylate, butyl methacrylate, isobutyl methacrylate, tert-butyl methacrylate, hexyl methacrylate, and etc. Examples of C3-C8 cycloalkyl acrylate include, but not limited to, cyclopropyl acrylate, cyclobutyl acrylate, cyclopentyl acrylate, cyclohexyl acrylate, and etc. Examples of C3-C8 cycloalkyl methacrylate include, but are not limited to, cyclopropyl methacrylate, cyclobutyl methacrylate, cyclopentyl methacrylate, cyclohexyl methacrylate, and etc. Examples of C6-C12 aryl acrylate include, but are not limited to, phenyl acrylate, naphthalene acrylate, and etc. Examples of C6-C12 aryl methacrylate include, but are not limited to, phenyl methacrylate, naphthalene methacrylate, and etc. In some implementations, C1-C10 alkyl is preferably C1-C6 alkyl, C3-C8 alkyl is preferably C3-C6 alkyl, and C6-C12 aryl is preferably C6-C10 aryl. Monomers with short carbon chains (monomers with a C number smaller than or equal to 8) are preferred. Preferably, the polymerizable monomers of the (meth)acrylate polymer comprise monomers selected from the following: methyl acrylate, ethyl acrylate, butyl acrylate, methyl methacrylate, isobutyl acrylate, isobutyl methacrylate, 2-ethylhexyl acrylate, tert-butyl methacrylate, acryloyl morpholine, isooctyl acrylate, isooctyl methacrylate, tetrahydrofuran acrylate, tetrahydrofuran methacrylate, isobornyl acrylate, isobornyl methacrylate, hydroxyethyl acrylate, hydroxyethyl methacrylate, hydroxypropyl acrylate, hydroxybutyl acrylate, vinyl acetate, cyclohexyl acrylate, 2-phenoxyethyl acrylate, 2-phenoxyethyl methacrylate, glycidyl acrylate, and glycidyl methacrylate.

The polymerizable monomers of the (meth)acrylate polymer may further preferably comprise acrylic acid and methacrylic acid, so as to provide the carboxyl group. The polymerizable monomers of the (meth)acrylate polymer may further preferably comprise mono-2-(methacryloyloxy)ethyl succinate or mono-2-(acryloyloxy)ethyl succinate, so as to provide the carboxyl group.

The (meth)acrylate polymer having the carboxyl functional group described above may be synthesized by method of free radical polymerization. The used solvent includes, but not limited to, ester, alcohol, ketone, carboxylic acid, aliphatic hydrocarbon, cycloalkane, haloalkane, aromatic hydrocarbon, etc. Specifically, the used solvent includes, but not limited to, ethyl acetate, n-butanol, acetone, acetic acid, benzene, toluene, ethylbenzene, cumene, tert-butyl benzene, heptane, cyclohexane, chloro-n-butane, bromo-n-butane, iodine-n-butane, and etc. The solvent may be any one of the above compounds or a mixture of more than two of the above compounds.

Suitable cationic photocatalysts are described in U.S. Pat. No. 5,709,948 (Perez et al.), including but not limited to the following compounds: diaryl iodonium salt, triaryl sulfonium salt, alkyl sulfonium salt, iron aromatic hydrocarbon salt, sulfonyloxanone, and triaryl siloxane. In some embodiments, the following compounds are used: triarylsulfonium hexafluorophosphate salts or hexafluoroantimonate salts, sulfonium hexafluoroantimonate salts, sulfonium hexafluorophosphate salts, and iodonium hexafluorophosphate salts.

The amount of the carboxyl functional groups in the (meth)acrylate polymer having the carboxyl functional group should not be too low, and the amount of the carboxyl functional group in every 100 g of the (meth)acrylate polymer having the carboxyl functional group must be equal to or greater than 40 mmol, namely, equal to or greater than 40 mmol/100 g.

Preferably, the amount of the carboxyl functional group in the (meth)acrylate polymer having the carboxyl functional group is 41 mmol/100 g to 83 mmol/100 g.

In the composition of the present invention, the amount of (meth)acrylate polymer having the carboxyl functional group is at least 81 parts by weight. The amount of (meth)acrylate polymer having the carboxyl functional group is up to 97.5 parts by weight. When the content is too low, the initial adhesiveness of the pressure-sensitive adhesive composition is poor. Likewise, when the content is too high, the anti-repulsion of the pressure-sensitive adhesive composition is poor.

The glass transition temperature (Tg) of the (meth)acrylate polymer having the carboxylic functional group is preferably in the range from −40° C. to 20° C. The lower limit of the glass transition temperature is preferably −30° C., and more preferably −20° C. The upper limit of the glass transition temperature is preferably 10° C., and more preferably 0° C. The lower the Tg, the better the initial adhesiveness of the adhesive tape, but the lower the shear strength; and on the contrary, the higher the Tg, the poorer the initial adhesiveness of the adhesive tape, and the higher the shear strength. In this case, the tape will suffer from brittleness. Tg of the polymer can be determined by a method commonly used in the art such as DSC, or can be calculated through the FOX equation.

The FOX equation is an equation used to describe the relationship between Tg of a copolymer and Tg of a homopolymer constituting the component of the copolymer. For example, for a copolymer constituted by monomer units A, B, C and the like, Tg thereof can be represented by following formula:

$$\frac{1}{Tg} = \frac{{W}_{A}}{{Tg}_{A}} + \frac{{W}_{B}}{{Tg}_{B}} + \frac{{W}_{C}}{{Tg}_{C}} + …$$

wherein
Tg is Tg of the copolymer;
W_{A}, W_{B} and W_{C} are the mass percentage of the monomer units A, B and C respectively;
Tg_{A}, Tg_{B}, Tg_{C} and the like are Tg of homopolymer A, homopolymer B, homopolymer C and the like respectively.

b) Epoxy Resin

The UV-curable pressure-sensitive adhesive composition provided by the present invention comprises an epoxy resin. In some implementations, epoxy resin molecules contain more than two epoxy groups. Specifically, the present invention may use alicyclic epoxy resins such as glycidyl ethers obtained by reaction of polyphenols such as bisphenol A, bisphenol F, bisphenol S, hexahydrobisphenol A, tetramethyl bisphenol A, diaryl bisphenol A, and tetramethyl bisphenol F with epichlorohydrin, epoxidized polyolefins, and other well-known epoxy resins.

The content of the epoxy resin greatly influences the anti-repulsion of the pressure-sensitive adhesive composition. A suitable crosslink density is a key factor for increasing the anti-repulsion. Before curing, the cohesive strength should be sufficiently high to maintain the repulsive force, and the viscosity should be sufficient to wet the substrate. After curing, the crosslink density should appropriately increase the anti-repulsion.

The inventor unexpectedly found that, in the composition provided by the present invention, when the amount of the (meth)acrylate polymer having the carboxyl functional group is 81 to 97.5 parts by weight, and the amount of the epoxy resin is 2.5 to 19 parts by weight, the composition has excellent anti-repulsion. When the content of the epoxy resin in the two components increases, the anti-repulsion of the prepared pressure-sensitive adhesive composition decreases. For example, when the amount of the epoxy resin is too high, the anti-repulsion of pressure-sensitive adhesive composition will decrease. When the amount of the epoxy resin is too small, the anti-repulsion is also impacted. More preferably, in the UV-curable pressure-sensitive adhesive composition provided by the present invention, the amount of the epoxy resin is 5-10 parts by weight.

c) Polyol

The polyol acts as a chain transfer agent in reaction according a cationic mechanism.

Examples of the polyols that can be used include, but not limited to, polyether polyols such as polyether triols or polyether diols, polyester polyols such as polyester triols or polyester diols, bisphenol A polyols, and etc. One or a mixture of more of the above polyols may be used. Commercially-available products include TONE 0230 Polyol, VORANOL 230-238, VARONOL 2070 manufactured by Dow Chemical, DIANOL 285 manufactured by Seppic (France), and etc. In some embodiments, VARONOL 2070 manufactured by Dow Chemical (USA) is used.

The lower limit of the content of the above polyol in the UV-curable pressure-sensitive adhesive composition of the present invention is 0.3 parts by weight, or 0.5 parts by weight, or 2 parts by weight, whereas the upper limit of the content is 6 parts by weight. The content of the polyol is preferably 2 to 6 parts by weight, or 2 to 4 parts by weight. When the content of the polyol is too low, the UV-curable pressure-sensitive adhesive tape has poor anti-repulsion after curing; when the content of the polyol is too high, the adhesive tape after curing will be too soft, which will affect the anti-repulsion.

d) Photoinitiator

The amount of the photoinitiator used in the UV-curable pressure-sensitive adhesive composition in a reactive polyacrylate/epoxy resin hybrid system with reactive functional groups is very small, but the amount thereof has a great impact on the curing speed and storage stability of the UV-curable pressure-sensitive adhesive composition.

The photoinitiator may be a cationic photoinitiator. Suitable cationic photoinitiators including but not limited to the following compounds: diaryl iodonium salt, triaryl sulfonium salt, alkyl sulfonium salt, iron aromatic hydrocarbon salt, sulfonyloxanone, and triaryl siloxane. In some embodiments, the following compounds are used: triarylsulfonium hexafluorophosphate salts or hexafluoroantimonate salts, sulfonium hexafluoroantimonate salts, sulfonium hexafluorophosphate salts, and iodonium hexafluorophosphate salts.

The onium salt photoinitiator applicable to the present invention includes, but not limited to, iodonium and sulfonium complex salts. Useful aromatic iodonium complex salts include a salt of a general formula as follows:

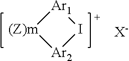

Ar₁ and Ar₂ are identical or different, each comprising aryl having about 4 to 20 carbon atoms. Z is selected from the group consisting of oxygen, sulfur, carbon-carbon bonds;

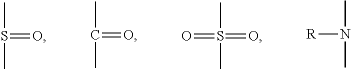

R may be aryl (having about 6 to 20 carbon atoms, such as phenyl) or acyl (having about 2 to 20 carbon atoms, such as acetyl or benzoyl); and

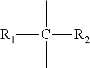

R₁ and R₂ are selected from the group consisting of hydrogen, alkyl having about 1 to 4 carbon atoms, and alkenyl having about 2 to 4 carbon atoms.

m is 0 or 1; and

X has a DQn chemical equation, where D is a metal in families IB to VIII or nonmetal in families from IIIA to VA in the periodic table of elements, or a combination thereof, D also includes hydrogen; Q is halogen atom; and n is an integer within 1 to 6. The metal is preferably copper, zinc, titanium, vanadium, chromium, magnesium, manganese, iron, cobalt, or nickel, and the nonmetal is advantageously boron, aluminium, antimony, tin, arsenic and phosphorus. Halogen Q is preferably chlorine or fluorine. Suitable examples of anions include, but are not limited to, BF₄⁻, PF₆⁻, SbF₆⁻, FeCl₄⁻, SnCl₅⁻, AsF₆⁻, SbF₅OH⁻, SbCl₆⁻, SbF₅⁻², AlF₅⁻², GaCl₄⁻, InF₄⁻, TiF₆⁻², ZrF₆⁻, and CF₃SO₃⁻. The anions are preferably BF₄⁻, PFK₆⁻, SbF₆⁻, AsF₆⁻, SbF₅OH⁻, and SbCl₆⁻. More preferably, the anions are SbF₆⁻, AsF₆⁻ and SbF₅OH⁻.

More preferably, Ar₁ and Ar₂ are selected from the group consisting of phenyl group, thienyl group, furanyl group, and pyrazolyl group. The Ar₁ and Ar₂ groups may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

Aomatic sulfonium complex salt initiators applicable to the present invention may be expressed by the following general formula:

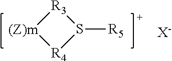

wherein R₃, R₄ and R₅ are identical or different, provided that at least one of R₃, R₄ and R₅ is aryl. R₃, R₄ and R₅ may be selected from the group consisting of aromatic portions comprising about 4 to 20 carbon atoms (e.g., substituted and unsubstituted phenyl, thienyl and furyl) and alkyl comprising about 1 to 20 carbon atoms. R₃, R₄ and R₅ are each preferably an aromatic portion; and Z, m, and X are all those as defined for the iodonium complex salt above.

If R₃, R₄ and R₅ are aromatic groups, they may optionally comprise one or a plurality of condensed benzocycles (e.g., naphthyl, benzothienyl, dibenzothienyl, benzofuranyl, and dibenzofuranyl). The aryl groups may also be substituted by one or a plurality of non-alkaline groups as required, if they do not substantially react with epoxy compounds and hydroxy functional groups.

In one example of the present invention, triaryl substituted salts such as triphenyl hexafluoroantimonate and p-phenyl (phenylthio) biphenyl sulfonium hexafluoroantimonate are required sulfonium salts. Other useful sulfonium salts in the present invention are described such as those in U.S. Pat. No. 4,256,828 (Smith) and U.S. Pat. No. 4,173,476 (Smith et al.).

Another type of photoinitiators applicable to the present invention includes photo-activable organic metallic complex salts, such as those described in U.S. Pat. No. 5,059,701 (Keipert), U.S. Pat. No. 5,191,101 (Palazzotto et al.), and U.S. Pat. No. 5,252,694 (Willett et al.). These organic metal cationic salts have a general formula as follows:

[(L₁)(L₂)Mₘ]e⁺X⁻

where Mₘ represents an element selected from families IVB, VB, VIB, VIIB, and VIII in the periodic table of elements, and is preferably Cr, Mo, W, Mn, Re, Fe or Co; L₁ represents no ligand, or 1 or 2 ligands that contribute π electrons, wherein the ligands may be the same or different, and each ligand may be selected from the group consisting of carbocyclic aromatic and heterocyclic aromatic compounds which are substituted and unsubstituted by substituted and unsubstituted alicyclic and cyclic unsaturated compounds. Each of the compounds may contribute 2 to 12 pi electrons to a valence shell of the metal atom M. L₁ is advantageously selected from the group consisting of substituted and unsubstituted η3-allyl, η5-cyclopentadienyl and η7-cycloheptane compounds, and η6-aromatics from η6-benzene and substituted η6-benzene compounds (e.g., xylene) and compounds with 2-4 fused rings, each ring being able to contribute 3 to 8π electrons to the valence shell of metal atom M.

L₂ represents no ligand or one to three ligands that contribute an even number of σ electrons, wherein the ligands may be the same or different, and each ligand may be selected from the group consisting of carbon monoxide, nitrite onium, triphenylphosphine, triphenylantimony, and phosphorus, arsenic, antimony derivatives, under the condition that the total charges contributed by L₁ and L₂ to Mₘ result in net residual positive charges to e of a complex.

e is an integer of 1 or 2, the residual charge in coordination with cations; and X is a halogen-containing anion in coordination, as stated above.

Examples of organic metal complex cationic salts suitable for use as the photo-activable catalysts in the present invention include, but not limited to, the following:
[(η6-benzene)(η5-cyclopentadienyl)Fe]⁺[SbF₆]⁻,
[(η6-toluene)(η5-cyclopentadienyl)Fe]⁺[AsF₆]⁻,
[(η6-xylene)(η5-cyclopentadienyl)Fe]⁺[SbF₆]⁻,
[(η6-isopropylbenzene)(η5-cyclopentadienyl)Fe]⁺[SbF₆]⁻,
[(η6-xylene (mixed isomer))(η5-cyclopentadienyl)Fe]⁺[SbF₆]⁻,
[(η6-xylene (mixed isomer))(η5-cyclopentadienyl)Fe]⁺[PF₆]⁻,
[(η6-o-xylene)(η5-cyclopentadienyl)Fe]⁺[CF₃SO₃]⁻,
[(η6-m-xylene)(η5-cyclopentadienyl)Fe]⁺[BF₄]⁻,
[(η6-1,3,5-trimethylbenzene)(η5-cyclopentadienyl)Fe]⁺[SbF₆]⁻,
[(η6-hexamethylbenzene)(η5-cyclopentadienyl)Fe]⁺[SbF₅OH]⁻,
[(η6-fluorene)(η5-cyclopentadienyl)Fe]⁺[SbF₆]⁻.

In one example of the present invention, the required organic metal complex cationic salts include one or more of the following compounds:
[(η6-xylene (mixed isomer))(η5-cyclopentadienyl)Fe]⁺[SbF₆]⁻,
[(η6-xylene (mixed isomer))(η5-cyclopentadienyl)Fe]⁺[PF₆]⁻,
[(η6-xylene)(η5-cyclopentadienyl)Fe]⁺[SbF₆]⁻,
[(η6-1,3,5-trimethylbenzene)(η5-cyclopentadienyl)Fe]⁺[SbF₆]⁻,

Suitable commercially-available initiators include, but not limited to, DOUBLECURE1176, 1193 (Double Bond Chemical Ind. Co., Ltd.) and IRGACURE™ 261, and cationic organic metallic complex salts (BASF). Photoinitiators include, but not limited to, azo initiators and peroxide initiators, such as azobisisobutyronitrile (AIBN), azodiisoheptanitrile (ABVN), 2,2′-azo-bis-(2-methylbutyronitrile) (AMBN), benzoyl peroxide (BPO), and persulfate.

In the composition of the present invention, the content of the photoinitiator is 0.05 to 5 parts by weight, preferably 1-2 parts by weight. Generally speaking, the curing speed of the adhesive composition increases as a result of an increase of the content of the photoinitiator. When the amount of the used photoinitiator is too low, the required radiation energy of UV during curing is high, and the curing speed is slow. On the contrary, when the amount of the used photoinitiator is too great, the required radiation energy of UV during is very low and the curing speed is too fast. Even under sunlight or fluorescent lamp light (containing a small amount of UV light), the photoinitiator can be cured, thereby impacting the storage stability at room temperature.

According to another aspect of the present invention, the present invention provides a UV-curable pressure-sensitive adhesive tape, which comprises a UV-curable pressure-sensitive adhesive layer formed by the UV-curable pressure-sensitive adhesive composition in any embodiment described in the present invention.

The UV-curable pressure-sensitive adhesive tape may be a one-sided or two-sided adhesive tape. The one-sided or two-sided adhesive tape comprises a substrate layer and a pressure-sensitive adhesive layer formed by the UV-curable pressure-sensitive adhesive composition on the substrate layer.

The substrate may be any of the substrates commonly used in the field, such as a film formed by one or more substances selected from the group consisting of polyester, polycarbonate, polyamide, polyimide, polyacrylate, and polyolefin. Examples of the substrate include, but not limited to, polyethylene terephthalate (PET) films, polyimide (PI) films, polypropylene (PP) films, polyethylene (PE) films, etc. The thickness of the substrate may be 2-2000 microns, preferably 5-1000 microns, and more preferably 10 to 500 microns.

The UV-curable pressure-sensitive adhesive layer may be obtained by coating the pressure-sensitive adhesive composition on the substrate by a conventional coating method, and then heating to remove the solvent to form an adhesive film with a certain thickness. Release paper or a release film with a certain thickness may be added to the adhesive film.

When the conventional coating method is used, if viscosity of the UV-curable pressure-sensitive adhesive composition is too high or too low, effective coating is not achieved. However, viscosity may be adjusted by adding a solvent. Selectable solvents include ester, alcohol, ketone, carboxylic acid, aliphatic hydrocarbon, cycloalkane, halogenated alkane, aromatic hydrocarbon, etc. An example of the solvent includes, but is not limited to, any one or a mixture of more of ethyl acetate, n-butanol, isopropanol, acetone, acetic acid, benzene, toluene, ethylbenzene, isopropyl benzene, tert-butyl benzene, heptane, cyclohexane, chlorobutane, bromobutane and iodobutane.

Usable coating methods include roll/scraper coating, comma roller coating, dragging blade coating, reverse roll coating, Mayer coating, gravure roll coating, slit die extrusion coating, etc. Preferred coating methods are comma roll coating and slit die extrusion coating.

The thickness of the pressure-sensitive adhesive layer (dry adhesive thickness) may be within 8 to 250 microns, and the preferred thickness is within 10-75 microns. Thickness of the pressure-sensitive adhesive layer that is too high or too low is not conducive to coating and use.

In some implementations, the UV-curable pressure-sensitive adhesive tape further comprises a protective layer, such as release paper. The protective layer contacts the outer surface of the pressure-sensitive adhesive layer, namely, the protective layer contacts the surface opposite the contact surface between the pressure-sensitive adhesive layer and the substrate, and can have the function of protecting the pressure-sensitive adhesive layer. When in use, the protective layer is peeled off and the pressure-sensitive adhesive layer is exposed for use. The release paper may be of any type commonly used in the field. Materials that can be used as the protective layer include, but are not limited to, cellophane, laminated paper, polyester film, polypropylene film, etc., and are preferably coated with silicone resin. The UV-curable pressure-sensitive adhesive tape may also be an adhesive film without a substrate layer or a double-sided coated adhesive tape. The double-sided coated adhesive tape may be a double-sided coated cotton adhesive tape, a double-sided coated PET adhesive tape, or a double-sided coated thin foam adhesive tape.

### LIST OF EMBODIMENTS

1. A UV-curable pressure-sensitive adhesive composition, comprising:
   81 to 97.5 parts of (meth)acrylate polymer having a carboxyl functional group by weight, the amount of the carboxyl functional group in the (meth)acrylate polymer having the carboxyl functional group being equal to or greater than 40 mmol/100 g;
      2.5 to 19 parts of an epoxy resin by weight;
      0.3 to 6 parts of a polyol by weight; and
      0.05 to 5 parts of a photoinitiator by weight.
2. The UV-curable pressure-sensitive adhesive composition according to embodiment 1, wherein the (meth)acrylate polymer having the carboxyl functional group is formed through copolymerization by using a raw material comprising at least two polymerizable monomers, the polymerizable monomers comprising at least one monomer having the carboxyl functional group.
3. The UV-curable pressure-sensitive adhesive composition according to embodiment 1 or 2, wherein the monomer having the carboxyl functional group comprises acrylic acid, methacrylic acid, mono-2-(methacryloyloxy)ethyl succinate, and mono-2-(acryloyloxy)ethyl succinate.
4. The UV-curable pressure-sensitive adhesive composition according to any one of embodiments 1 to 3, wherein the polymerizable monomers comprise one or more substances from the group consisting of methyl acrylate, ethyl acrylate, butyl acrylate, methyl methacrylate, isobutyl acrylate, isobutyl methacrylate, 2-ethylhexyl acrylate, tert-butyl methacrylate, acryloyl morpholine, isooctyl acrylate, isooctyl methacrylate, tetrahydrofuran acrylate, tetrahydrofuran methacrylate, isobornyl acrylate, isobornyl methacrylate, hydroxyethyl acrylate, hydroxyethyl methacrylate, hydroxypropyl acrylate, hydroxybutyl acrylate, vinyl acetate, cyclohexyl acrylate, 2-phenoxyethyl acrylate, 2-phenoxyethyl methacrylate, glycidyl acrylate and glycidyl methacrylate.
5. The UV-curable pressure-sensitive adhesive composition according to any one of embodiments 1 to 4, wherein the amount of the carboxyl functional group in the (meth)acrylate polymer having the carboxyl functional group is 41 mmol/100 g to 83 mmol/100 g.
6. The UV-curable pressure-sensitive adhesive composition according to any one of embodiments 1 to 4, wherein the amount of the polyol is 2 to 6 parts by weight.
7. The UV-curable pressure-sensitive adhesive composition according to any one of embodiments 1 to 4, wherein the glass transition temperature of the (meth)acrylate polymer having the carboxyl functional group is in the range from −40° C. to 20° C.
8. The UV-curable pressure-sensitive adhesive composition according to any one of embodiments 1 to 4, further comprising a solvent.
9. A UV-curable pressure-sensitive adhesive tape, comprising:
a UV-curable pressure-sensitive adhesive layer formed by the UV-curable pressure-sensitive adhesive composition according to any one of embodiments 1 to 8.
10. The UV-curable pressure-sensitive adhesive tape according to embodiment 9, wherein the thickness range of the UV-curable pressure-sensitive adhesive layer is 8 to 250 μm.

The present invention will be further described in the embodiments below.

Raw materials used in synthesis examples, embodiments and comparative examples are summarized in Table 1.

TABLE 1

| Name | Substance | Manufacturer or supplier |
|---|---|---|
| MA | Methyl acrylate | Huayi, China |
| BA | Butyl acrylate | Huayi, China |
| AA | Acrylic acid | Huayi, China |
| GMA | Glycidyl methacrylate | Mitsubishi, Japan |
| EA | Ethyl acetate | Sinopharm, China |
| VAZO 67 | Initiator | Dupont, China |
| EPON828 | Epoxy resin | Hexion, China |
| 1176 | Cationic photoinitiator | Double bond Chemical Co., China |
| 1190 | Cationic photoinitiator | Double bond Chemical Co., China |
| RD1054 | Aziridine cross-linking agent | 3M, China |
| V2070 | Polyol | Dow Chemical, China |

Firstly, different acrylate polymers are prepared through the following synthesis examples. The following are solvent-based (methyl) acrylic polymers.

### Synthesis Example 1

49 parts of MA, 45 parts of BA, 6 parts of AA, 0.2 parts of VAZO 67, and 150 parts of EA were mixed in a glass bottle. Nitrogen was fed for 2 minutes to remove oxygen and then the glass bottle was sealed. The reaction bottle was placed in polymerization equipment for polymerization reaction at a temperature of 60° C. for 24 hours to prepare a solvent-based (methyl) acrylic polymer with a solid content of 40%. The content of the carboxyl group in the synthesized polymer was 83 mmol/100 g, recorded as Polyacrylate-1.

### Synthesis Example 2

49 parts of MA, 44.5 parts of BA, 6 parts of AA, 0.5 parts of VAZO 67, and 150 parts of EA were mixed in a glass bottle. Nitrogen was fed for 2 minutes to remove oxygen and then the glass bottle was sealed. The reaction bottle was placed in polymerization equipment for polymerization reaction at a temperature of 60° C. for 24 hours to prepare a solvent-based (methyl) acrylic polymer with a solid content of 40%. The content of the carboxyl group in the synthesized polymer was 83 mmol/100 g, recorded as Polyacrylate-2.

### Synthesis Example 3

55 parts of MA, 42 parts of BA, 3 parts of AA, 0.2 parts of VAZO 67, and 150 parts of EA were mixed in a glass bottle. Nitrogen was fed for 2 minutes to remove oxygen and then the glass bottle was sealed. The reaction bottle was placed in polymerization equipment for polymerization reaction at a temperature of 60° C. for 24 hours to prepare a solvent-based (methyl) acrylic polymer with a solid content of 40%. The content of the carboxyl group in the synthesized polymer was 41.6 mmol/100 g. recorded as Polyacrylate-3.

### Synthesis Example 4

58.5 parts of MA, 40 parts of BA, 1 part of AA, 0.5 parts of GMA, 0.2 parts of VAZO 67, and 150 parts of EA were mixed in a glass bottle. Nitrogen was fed for 2 minutes to remove oxygen and then the glass bottle was sealed. The reaction bottle was placed in polymerization equipment for polymerization reaction at a temperature of 60° C. for 24 hours to prepare a solvent-based (methyl) acrylic polymer with a solid content of 40%. The content of the carboxyl group in the synthesized polymer was 14 mmol/100 g, recorded as Polyacrylate-4.

### Synthesis Example 5

52 parts of MA, 43 parts of BA, 5 parts of GMA, 0.2 parts of VAZO 67, and 150 parts of EA were mixed in a glass bottle. Nitrogen was fed for 2 minutes to remove oxygen and then the glass bottle was sealed. The reaction bottle was placed in polymerization equipment for polymerization reaction at a temperature of 60° C. for 24 hours to prepare a solvent-based (methyl) acrylic polymer with a solid content of 40%. The synthesized polymer did not contain the carboxyl functional group, recorded as Polyacrylate-5.

### Synthesis Example 6

57.5 parts of MA, 44 parts of BA, 2 parts of AA, 0.5 part of GMA, 0.2 part of VAZO 67 and 150 parts of EA were mixed in a glass bottle. Nitrogen was fed therein for 2 min to remove oxygen and the bottle was sealed. The reaction bottle was kept in the polymerization equipment at a temperature of 60° C. to perform polymerization reaction for 24 h, so as to prepare the solvent-based (methyl)acrylic polymer 2 with a solid content of 40%. The content of the carboxyl group in the synthesized polymer was 28 mmol/100 g, recorded as Polyacrylate-6.

Then, the solvent-based acrylate polymers prepared in the synthesis examples were used to prepare the adhesive tapes in the embodiments and the comparative examples.

### Embodiment 1

202.5 parts of the solution of the polymer (dry weight: 40%) prepared in synthesis example 1, 19 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 2

202.5 parts of the solution of the polymer (dry weight: 40%) prepared in synthesis example 2, 19 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 3

225 parts of the solution of the polymer (dry weight: 40%) prepared in synthesis example 2, 10 parts of EPON 828, 1 part of 1176, and 2 parts of V2070 were mixed uniformly to prepare a mixed solution; the mixed solution was coated on release film which was then dried at a temperature of 100° C. for 10 min; the thickness of the dry film was 75 μm, and after drying, the surface of the adhesive film was covered with another release film.

### Embodiment 4

231.2 parts of the solution of the polymer (dry weight: 40%) prepared in synthesis example 2, 7.5 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 5

237.5 parts of the solution of the polymer (dry weight: 40%) prepared in synthesis example 2, 5 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 6

243.7 parts of the solution of the polymer (dry weight: 40%) prepared in synthesis example 2, 2.5 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 7

237.5 parts of the solution of the polymer (dry weight: 40%) prepared in synthesis example 2, 5 parts of EPON 828, 1 part of 1190, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 8

237.5 parts of the solution of the polymer (dry weight: 40%) prepared in synthesis example 3, 5 parts of EPON 828, 1 part of 1190, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 9

237.5 parts of the solution of the polymer (dry weight: 40%) prepared in synthesis example 2, 5 parts of EPON 828, 1 part of 1190, and 0.5 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Embodiment 10

202.5 parts of the solution of the polymer (dry weight: 40%) prepared in synthesis example 2, 19 parts of EPON 828, 1 part of 1176, and 6 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 1

175 parts of the solution of the polymer (dry weight: 40%) prepared in synthesis example 2, 30 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 2

250 parts of the solution of the polymer (dry weight: 40%) prepared in synthesis example 2, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 3

202.5 parts of the solution of the polymer (dry weight: 40%) prepared in synthesis example 5, 19 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 4

237.5 parts of the solution of the polymer (dry weight: 40%) prepared in synthesis example 5, 5 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 5

202.5 parts of the solution of the polymer (dry weight: 40%) prepared in synthesis example 4, 19 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 6

237.5 parts of the solution of the polymer (dry weight: 40%) prepared in synthesis example 4, 5 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 7

250 parts of the solution of the polymer (dry weight: 40%) prepared in synthesis example 2 and 0.1 part of cross-linking agent RD1054 were mixed uniformly to prepare a mixed solution; the mixed solution was coated on a release film which was then dried at 105° C. for 10 min; the thickness of the dry film was 75 μm, and after drying, the surface of the adhesive film was covered with another release film.

### Comparative Example 8

250 parts of the solution of the polymer (dry weight: 40%) prepared in synthesis example 3 and 0.1 part of cross-linking agent RD1054 were mixed uniformly to prepare a mixed solution; the mixed solution was coated on a release film which was then dried at a temperature of 105° C. for 10 min; the thickness of the dry film was 75 μm, and after drying, the surface of the adhesive film was covered with another release film.

### Comparative Example 9

250 parts of the solution of the polymer (dry weight: 40%) prepared in synthesis example 2 and 0.04 part of cross-linking agent RD1054 were mixed uniformly to prepare a mixed solution; the mixed solution was coated on a release film which was then dried at a temperature of 105° C. for 10 min; the thickness of the dry film was 75 μm, and after drying, the surface of the adhesive film was covered with another release film.

### Comparative Example 10

250 parts of the solution of the polymer (dry weight: 40%) prepared in synthesis example 3 and 0.04 part of cross-linking agent RD1054 were mixed uniformly to prepare a mixed solution; the mixed solution was coated on a release film which was then dried at a temperature of 105° C. for 10 min; the thickness of the dry film was 75 μm, and after drying, the surface of the adhesive film was covered with another release film.

### Comparative Example 11

202.5 parts of the solution of the polymer (dry weight: 40%) prepared in synthesis example 2, 19 parts of EPON 828, and 1 part of 1176 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 12

202.5 parts of the solution of the polymer (dry weight: 40%) prepared in synthesis example 2, 19 parts of EPON 828, 1 part of 1176, and 8 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

### Comparative Example 13

202.5 parts of the solution of the polymer (dry weight: 40%) prepared in synthesis example 6, 19 parts of EPON 828, 1 part of 1176, and 2 parts of V2070 were mixed uniformly to prepare a mixed solution; the mixed solution was coated on a release film which was then dried at a temperature of 100° C. for 10 min; the thickness of the dry film was 75 μm, and after drying, the surface of the adhesive film was covered with another release film.

Specific formulations for Embodiment 1 to 10 and Comparative example 1 to 13 are described in Table 2.

TABLE 2

| | Polyacrylate | Tg of | Carboxyl | Epoxy | | | Cross- |
|---|---|---|---|---|---|---|---|
| | polymer | Polyacrylate | functional | resin | Polyol | Photoinitiator | linking |
| | (parts by | polymer | group content | (parts by | (parts by | (parts by | agent (parts |
| | weight) | (° C.) | (mmol/100 g) | weight) | weight) | weight) | by weight) |
| E1 | 81 | −20 | 83 | 19 | 2 | 1 | |
| E2 | 81 | −20 | 83 | 19 | 2 | 1 | |
| E3 | 90 | −20 | 83 | 10 | 2 | 1 | |
| E4 | 92.48 | −20 | 83 | 7.5 | 2 | 1 | |
| E5 | 95 | −20 | 83 | 5 | 2 | 1 | |
| E6 | 97.48 | −20 | 83 | 2.5 | 2 | 1 | |
| E7 | 95 | −20 | 83 | 5 | 2 | 1 | |
| E8 | 95 | −20 | 41.6 | 5 | 2 | 1 | |
| E9 | 95 | −20 | 83 | 5 | 0.5 | 1 | |
| E10 | 81 | −20 | 83 | 19 | 6 | 1 | |
| C1 | 70 | −20 | 83 | 30 | 2 | 1 | |
| C2 | 100 | −20 | 83 | 0 | 2 | 1 | |
| C3 | 81 | −20 | 0 | 19 | 2 | 1 | |
| C4 | 95 | −20 | 0 | 5 | 2 | 1 | |
| C5 | 81 | −20 | 14 | 19 | 2 | 1 | |
| C6 | 95 | −20 | 14 | 5 | 2 | 1 | |
| C7 | 100 | −20 | 83 | 0 | 0 | 0 | 0.1 |
| C8 | 100 | −20 | 41.6 | 0 | 0 | 0 | 0.1 |
| C9 | 100 | −20 | 83 | 0 | 0 | 0 | 0.04 |
| C10 | 100 | −20 | 41.6 | 0 | 0 | 0 | 0.04 |
| C11 | 81 | −20 | 83 | 19 | 0 | 1 | |
| C12 | 81 | −20 | 83 | 19 | 8 | 1 | |
| C13 | 81 | −20 | 28 | 19 | 2 | 1 | |

In Embodiments 1 to 10, the UV-curable pressure-sensitive adhesive compositions are prepared according to the formulations provided by the present invention.

Test Methods:

In the present invention, the following tests and evaluations are performed to the samples obtained in the embodiments and comparative examples.

Test of Peeling Force after Curing

The force needed to peel off the adhesive tape at an angle of 180 degrees was tested and measured. Refer to the peeling force test method ASTM D3330 that was used to test the adhesive tapes obtained in the embodiments and the comparative examples. Details are as follows:

Nickel plated steel plates were used for the tests, and polyether ether ketone (PEEK) films were used as backing films. The nickel plated steel plates were wiped three times with isopropanol before tests.

An adhesive film (with thickness of about 30 μm) with PET release films on two sides were cut into 0.5×8 inches, the release films were removed, one side of the adhesive film was bonded to a nickel-plated steel plate, and rolling was performed twice by applying a force of 2 kg. UV (LED365 nm, 1.5-3 J/cm²) irradiation was performed to activate the curing process. After irradiation, the PET release film on the other side was removed immediately. The PEEK film with a thickness of about 20 μm and a width of 0.6 inches was bonded to the other side of the adhesive film, and rolling was performed twice with 2 kg of force.

After that, the test sample strips were cured for about 2-3 days in a controlled environment room (23° C./50% relative humidity), and then tests were performed; or the prepared sample strips were cured for 1 hour at an accelerated speed in an oven at 80° C. After being removed from the oven, the test sample strips were placed in the controlled environment room (23° C./50% relative humidity) for 1 day, and then measurement was performed.

Tests were performed by using a tension tester of Instron at speed of 12 in/min. Each test was repeated twice to get the average value in N/mm.

Anti-Repulsion Test

In this test, a 125 μm polyimide (PI) film was used as a substrate. The PI film was wiped three times with isopropanol before tests.

The PI film was cut into 30 mm×20 mm rectangular sample pieces. An adhesive film (with a thickness of about 75 μm) with PFE release films on two sides was cut into 20 mm×10 mm rectangular sample pieces, the PET release film on one side was removed and bonded to the PI film such that the side with a length of 20 mm of the adhesive film was in parallel with the side with a length of 20 mm of the PI film, and the distance between one side of the adhesive film and the side with a length of 20 mm of the PI film was about 2 mm.

The PET film on the other side was removed, UV irradiation (LED 365 nm, 1.5-3 J/cm²) was performed to activate the curing process, and the PI film was symmetrically folded such that the adhesive film stuck the folded PI film. Adhesive status was observed after curing for 8 hours at room temperature and after curing for 500 hours in a controlled environment of 23° C. and 50% relative humidity. Adhesive status was observed after curing for 8 hours at room temperature and after curing for 500 hours in a controlled environment of 23° C. and 50 00 relative humidity.

The results of anti-repulsion tests and peeling force tests for the embodiments and the comparative examples were shown in Table 3.

TABLE 3
Comparison of Anti-repulsion of Embodiments and
Comparative Examples

| | State after being | | Peeling |
|---|---|---|---|
| | placed at room | | force |
| | temperature | State after 65° C./ | Peel RT |
| | for 48 h | 95 H 500 h aging | (N/mm) |
| E1 | No lifting | No lifting | 0.66 |
| E2 | No lifting | No lifting | 0.69 |
| E3 | No lifting | No lifting | 0.72 |
| E4 | No lifting | No lifting | 0.70 |
| E5 | No lifting | No lifting | 0.72 |
| E6 | No lifting | No lifting | 0.75 |
| E7 | No lifting | No lifting | 0.68 |
| E8 | No lifting | No lifting | 0.65 |
| E9 | No lifting | No lifting | 0.66 |
| E10 | No lifting | No lifting | 0.69 |
| Cl | Lifting for 2 mm, CF | Opened, AF | 0.25 |
| C2 | No lifting | Lifting for 4 mm, CF + AF | 0.79 |
| C3 | Lifting for 2 mm, CF | Opened, AF | 0.36 |
| C4 | Lifting for 2 mm, CF | Opened, AF | 0.51 |
| C5 | Lifting for 2 mm, CF | Opened, AF | 0.46 |
| C6 | Lifting for 2 mm, CF | Lifting for 2 mm, CF | |
| C7 | No lifting | Lifting for 5 mm, AF | |
| C8 | No lifting | Lifting for 5 mm, AF+CF | |
| C9 | No lifting | Lifting for 2 mm, CF | |
| CIO | No lifting | Lifting for 5 mm, CF | |
| Cll | No lifting | Opened | 0.21 |
| C12 | Lifting for 2 mm, CF | Lifting for 2 mm, CF | |
| C13 | Lifting for 2 mm, CF | Opened, AF | |

CF refers to cohesive failure mode, and AF refers to adhesion failure mode,
C7-C10 are pressure-sensitive ad hesives which being triggered by hot pressing.

In Embodiments 1 to 10, the UV-curable pressure-sensitive adhesive compositions were prepared according to the formulations provided by the present invention and have excellent anti-repulsion and excellent peeling force (greater than 0.65 N/mm). Even after aging at a temperature of 65° C. and 95% humidity, no lifting or opening occurs.

In Embodiments 1, 2 and 8, different polyacrylate polymers are used in the UV-curable pressure-sensitive adhesive compositions, but the contents of the polymers and the content of the carboxyl functional groups therein are within the ranges of the present invention, and the prepared pressure-sensitive adhesive composition therein have desirable anti-repulsion and release force. In Embodiments 2 to 6, different contents of polyacrylate polymers and different contents of epoxy resins are used in the UV-curable pressure-sensitive adhesive compositions. The pressure-sensitive adhesive compositions prepared also have the desired anti-repulsion and release force of the present invention.

In Embodiments 2, 9 and 10, different contents of polyols are used, and the pressure-sensitive adhesive compositions prepared also have the desired anti-repulsion and release force of the present invention.

In Comparative examples 1 to 2, since the amounts of the (meth)acrylate polymers having the carboxyl functional groups and the epoxy resins are either too high or too low, the pressure-sensitive adhesive compositions prepared do not have the desired anti-repulsion of the present invention.

In Comparative examples 3 to 4, the (meth) acrylate polymers do not have the carboxyl functional groups. Although the amounts of (meth) acrylate polymers, epoxy resins, and polyols are within the ranges of the present invention, the pressure-sensitive adhesive compositions prepared do not have the desired anti-repulsion of the present invention.

In Comparative Examples 5, 6 and 13, although carboxyl groups are present in the (meth) acrylate polymers, the contents of the carboxyl functional groups are too low. The pressure-sensitive adhesive compositions prepared in Comparative examples 5, 6 and 13 still do not have the desired anti-repulsion of the present invention.

In the formulations of Comparative examples 7 to 10, epoxy resin and polyol are not included. Although the corresponding pressure-sensitive adhesive compositions have the anti-repulsion at room temperature, pop-up still occurs after aging.

The formulation of Comparative example 11 does not contain a polyol, the corresponding pressure-sensitive adhesive composition has the anti-repulsion at room temperature, but pop-up occurs after aging and the peel strength is relatively poor.

The content of the polyol in the formulation of Comparative example 12 is too high. The anti-repulsion is relatively poor.

From the comparison of the embodiments and comparative examples, it can be seen that when the contents of the four components of the present invention are within certain ranges, they can act synergistically, such that the prepared pressure-sensitive adhesive composition has excellent anti-repulsion to a plastic substrate, and failure does not occur even after aging by elevated temperature. Further, the composition has excellent peeling force for a metal substrate.

Certainly, the above embodiments of the present invention are only examples used for clearly describing the present invention, instead of limiting the embodiments of the present invention. One skilled in the art may make other forms of changes or variations on the basis of the above description. It is impossible to exhaust all the implementations herein. All obvious changes or variations derived from the technical solution of the present invention are still within the protection scope of the present invention.

1. A UV-curable pressure-sensitive adhesive composition, comprising:
81 to 97.5 parts of (meth)acrylate polymer having a carboxyl functional group by weight, the amount of the carboxyl functional group in the (meth)acrylate polymer having the carboxyl functional group being equal to or greater than 40 mmol/100 g;
2.5 to 19 parts of an epoxy resin by weight;
0.3 to 6 parts of a polyol by weight; and
0.05 to 5 parts of a photoinitiator by weight.

2. The UV-curable pressure-sensitive adhesive composition according to claim 1, wherein the (meth)acrylate polymer having the carboxyl functional group is formed through copolymerization by using a raw material comprising at least two polymerizable monomers, and the polymerizable monomers comprise at least one monomer having the carboxyl functional group.

3. The UV-curable pressure-sensitive adhesive composition according to claim 2, wherein the monomer having the carboxyl functional group comprises acrylic acid, methacrylic acid, mono-2-(methacryloyloxy)ethyl succinate, and mono-2-(acryloyloxy)ethyl succinate.

4. The UV-curable pressure-sensitive adhesive composition according to claim 2, wherein the polymerizable monomers comprise at least one or more substances from the group consisting of methyl acrylate, ethyl acrylate, butyl acrylate, methyl methacrylate, isobutyl acrylate, isobutyl methacrylate, 2-ethylhexyl acrylate, tert-butyl methacrylate, acryloyl morpholine, isooctyl acrylate, isooctyl methacrylate, tetrahydrofuran acrylate, tetrahydrofuran methacrylate, isobornyl acrylate, isobornyl methacrylate, hydroxyethyl acrylate, hydroxyethyl methacrylate, hydroxypropyl acrylate, hydroxybutyl acrylate, vinyl acetate, cyclohexyl acrylate, 2-phenoxyethyl acrylate, 2-phenoxyethyl methacrylate, glycidyl acrylate and glycidyl methacrylate.

5. The UV-curable pressure-sensitive adhesive composition according to claim 1, wherein the amount of the carboxyl functional group in the (meth)acrylate polymer having the carboxyl functional group is 41 mmol/100 g to 83 mmol/100 g.

6. The UV-curable pressure-sensitive adhesive composition according to claim 1, wherein the amount of the polyol is 2 to 6 parts by weight.

7. The UV-curable pressure-sensitive adhesive composition according to claim 1, wherein the glass transition temperature of the (meth)acrylate polymer having the carboxyl functional group is in the range from −40° C. to 20° C.

8. The UV-curable pressure-sensitive adhesive composition according to claim 1, further comprising a solvent.

9. A UV-curable pressure-sensitive adhesive tape, comprising:
a UV-curable pressure-sensitive adhesive layer formed by the UV-curable pressure-sensitive adhesive composition according to claim 1.

10. The UV-curable pressure-sensitive adhesive tape according to claim 9, wherein the thickness range of the UV-curable pressure-sensitive adhesive layer is 8 to 250 μm.
